(19) United States
(12) Patent Application Publication
(10) Pub. No.: US 2013/0343156 A1
(43) Pub. Date: Dec. 26, 2013

(54) Devices, Systems and Methods for Measuring Borehole Seismic Wavefield Derivatives

(71) Applicant: Steve Allan Horne, Perth (AU)

(72) Inventor: Steve Allan Horne, Perth (AU)

(21) Appl. No.: 13/531,588

(22) Filed: Jun. 25, 2012

(51) Int. Cl. G01V 1/40

(52) U.S. Cl. 367/25

(57) ABSTRACT

The disclosure provides devices, systems and methods for obtaining unaliased wavefield data despite using spatial sampling distances that are higher than conventional techniques and temporal sampling rates that are lower than conventional techniques. The devices can include an array of sensors for sampling a desired wavefield and at least one of its derivatives. The systems can include a multi-level array of such sensor configurations. The methods can include lowering such an array into a borehole and sampling data at distances that are greater than suggested by conventional theory, or lowering a multi-level array into a borehole and simultaneously gathering data at different depth levels.

### FIELD

The present disclosure relates to the study of underground formations and structures, for example as it relates to oil and gas exploration. The present disclosure relates more specifically to seismic surveying of subterranean geological formations.

### BACKGROUND

Borehole seismic survey systems often involve sources located at the surface and receivers placed in the well. Other configurations are possible, for example the drill bit can function as the seismic source and receivers can be placed at the surface. The distance between receivers may be governed by conventional sampling theory, which prescribes that any wavefield should be sampled at greater than twice the highest frequency component in the wavefield if there is to be no loss of information. This can impose an upper limit on receiver spacing requirements if there is to be no significant loss of spatial wavenumber information. In terms of borehole seismic this implies that there is a maximum spacing between receivers that cannot be exceeded if spatial aliasing is to be avoided. For conventional borehole seismic surveys, such as Vertical Seismic Profiles (“VSP”), this spacing is about 50 ft (15 m). The number of receivers deployed downhole may be limited for economic reasons, telemetry restrictions and safety reasons.

### SUMMARY

This disclosure relates to seismic devices, systems and methods for measuring an unaliased seismic wavefield using a reduced sampling rate compared to conventional sampling theory. In some embodiments, the seismic devices, systems and methods measure an unaliased seismic wavefield using a sampling requirement that is half that of conventional theory (e.g. according to some embodiments the spacing between receivers (groups of receivers) is twice the distance suggested by conventional theory). In some embodiments, the seismic devices, systems and methods measure an unaliased seismic wavefield using a sampling requirement that that is one-third that of conventional theory (e.g. according to some embodiments the spacing between receivers (groups of receivers) is three times the distance suggested by conventional theory).

More specifically, with respect to the seismic devices, in some embodiments, the device is a downhole tool that includes an array of at least two borehole seismic sensors configured to sample data corresponding to a desired wavefield and at least one of its derivatives. In further embodiments, the array includes two borehole seismic sensors configured to sample data corresponding to a desired wavefield and its first derivative. In further embodiments, the downhole tool includes an array of at least three borehole seismic sensors configured to sample data corresponding to a desired wavefield and both its first and second derivatives.

In some embodiments, the array includes at least two closely-spaced, same-type borehole seismic sensors. For example, in some embodiments these seismic sensors can be at least two closely-spaced displacement sensors. In some embodiments the seismic sensors can be at least two closely-spaced velocity sensors. In other embodiments, the seismic sensors can be at least two closely-spaced acceleration sensors. In some embodiments, the array includes at least two closely-spaced hydrophones, or at least two closely-spaced geophones, or at least two closely spaced accelerometers.

In some embodiments, the array includes at least two co-located sensors (i.e. effectively or substantially co-located sensors) of different types. For example, in some embodiments the sensors can be one displacement sensor and one velocity sensor and optionally one acceleration sensor, with the sensors being co-located at the same depth level (e.g. same axial position along the shuttle or drill string).

In some embodiments, the device is a downhole tool that includes an array of at least two borehole seismic sensors for sampling data corresponding to a desired wavefield and at least one of its derivatives (for example according to any one of the embodiments described herein) and the device also includes an electronics subsystem with machine-readable instructions for computing at least one wavefield derivative and/or an unaliased wavefield from the sampled data.

With respect to the systems, in some embodiments, the system includes a multi-level array of sensors, where each array includes at least two borehole seismic sensors for sampling data corresponding to a desired wavefield and at least one of its derivatives, and where the inter-array distance corresponds to a spatial sampling rate that is at least half, or that is at least one-third, the sampling rate suggested by conventional theory. In some embodiments, the inter-array distance ranges from about 60 feet to about 100 feet or to about 90 feet. In some embodiments, each array is according to one of the embodiments described in connection with the devices above. In some embodiments, the system also includes an electronics subsystem including machine-readable instructions for computing the wavefield derivatives, or the unaliased wavefield, or both.

With respect to the methods, in some embodiments, the method includes: deploying an array of at least two borehole seismic sensors to sample data corresponding to a wavefield and at least one of its derivatives in a borehole; firing a seismic source; collecting data at the sensors; and computing at least one wavefield derivative, or computing the unaliased wavefield, or both.

In some embodiments, the method includes lowering a wireline cable into a borehole, wherein the wireline cable includes at least two shuttles and the shuttles includes at least two sensors for sampling data corresponding to a wavefield and at least one of its derivatives, and the shuttles are separated by a distance resulting in an inter-array spacing that corresponds to a sampling rate that is at least half or at least one-third that suggested by conventional theory (i.e. resulting in an inter-array spacing that is at least twice or at least three times that suggested by conventional theory); firing a seismic source; collecting seismic data; and, computing the wavefield derivatives, the unaliased wavefield or both from the seismic data. In some embodiments, the wireline cable includes only one shuttle with an array of sensors for sampling data corresponding to a wavefield and at least one of its derivatives, and data is collected when (or each time) the shuttle moves a distance corresponding to a sample rate that is at least half or at least one-third suggested by conventional theory. For example, a seismic source may be fired and data may be collected every about 60 feet to about 100 feet as the shuttle is lowered into the borehole.

In some embodiments, the seismic sensors are deployed on a drill string which is lowered into a borehole as part of a Measurement-While-Drilling or Logging-While-Drilling operation. In some embodiments, the drill string includes a multi-level array with inter-array spacing corresponding to a sample rate that is at least half or at least one-third suggested by conventional theory (i.e. the distance between groups of receivers is at least twice or at least three times the distance between receivers suggested by conventional theory). In some embodiments, the drill string includes one array and measurements are taken as the drill string is lowered into the borehole and when it moves a distance (or each time it moves a distance) corresponding to a sample rate that is at least half, or at least one-third, the sampling rate suggested by conventional theory. For example, a seismic source may be fired and data may be collected every about 60 feet to about 100 feet as the drill string is lowered into the borehole.

The identified embodiments are exemplary only and are therefore non-limiting. The details of one or more non-limiting embodiments of the invention are set forth in the accompanying drawings and the descriptions below. Other embodiments of the invention should be apparent to those of ordinary skill in the art after consideration of the present disclosure.

### BRIEF DESCRIPTION OF DRAWINGS

FIG. 1A is a schematic illustration of a vertical seismic profiling operation that can be used with embodiments of devices, systems and methods of this disclosure.

FIG. 1B is a schematic illustration of another vertical seismic profiling operation that can be used with embodiments of devices, systems and methods of this disclosure.

FIG. 2 is a schematic illustration of a well data acquisition and logging system that can be used with embodiments of devices, systems and methods of this disclosure.

FIG. 3 is a schematic illustration of an embodiment of a device according to this disclosure.

FIG. 4 is a schematic illustration of another embodiment of a device according to this disclosure.

FIGS. 5A and 5B are together a schematic illustration of a conventional multi-level array of sensors as compared to a multi-level array of sensors according to an embodiment of this disclosure.

FIG. 6 is a graph of conventionally sampled data in the f-k domain along with a graph of the unaliased transformed data.

FIG. 7 is a graph of sparsely sampled data in the f-k domain along with a graph showing the consequent spatial aliasing.

FIG. 8 is a graph illustrating wavefield derivatives computed using a second order accurate central difference method from the closely spaced receivers in the sparsely sampled data set.

### DETAILED DESCRIPTION

Unless defined otherwise, all technical and scientific terms used herein have the same meaning as is commonly understood by one of ordinary skill in the art to which this disclosure belongs. In the event that there is a plurality of definitions for a term herein, those in this section prevail unless stated otherwise.

Where ever the phrases “for example,” “such as,” “including” and the like are used herein, the phrase “and without limitation” is understood to follow unless explicitly stated otherwise.

The terms “comprising” and “including” and “involving” (and similarly “comprises” and “includes” and “involves”) are used interchangeably and mean the same thing. Specifically, each of the terms is defined consistent with the common United States patent law definition of “comprising” and is therefore interpreted to be an open term meaning “at least the following” and is also interpreted not to exclude additional features, limitations, aspects, etc.

The term “about” is meant to account for variations due to experimental error. The term “substantially” (or alternatively “effectively”) is meant to permit deviations from descriptor that don't negatively impact the intended purpose. All measurements or numbers are implicitly understood to be modified by the word about, even if the measurement or number is not explicitly modified by the word about. Similarly, descriptive terms are implicitly understood to be modified by the word substantially, even if the term is not explicitly modified by the word substantially. For example, the phrase “co-located sensors” is understood to mean “substantially co-located” or “effectively co-located” sensors.

The terms “wellbore” and “borehole” are used interchangeably.

“Measurement While Drilling” (“MWD”) can refer to devices for measuring downhole conditions including the movement and location of the drilling assembly contemporaneously with the drilling of the well. “Logging While Drilling” (“LWD”) can refer to devices concentrating more on the measurement of formation parameters. While distinctions may exist between these terms, they are also often used interchangeably. For purposes of this disclosure MWD and LWD are used interchangeably and have the same meaning. That is, both terms are understood as related to the collection of downhole information generally, to include, for example, both the collection of information relating to the movement and position of the drilling assembly and the collection of formation parameters.

An “array” or “group” of sensors is a set of sensors configured to measure a wavefield and at least one of the wavefield's derivatives. The “array” or “group” can be a set of sensors of different types located at the same depth level, or else the “array” or “group” can be a set of sensors of the same type that is spatially separated by an amount appropriate to acquire data from which the wavefield can be measured and at least one of the wavefield's derivatives can be computed.

A “multi-level array” of sensors is a set of groups of sensors (a set of sensor arrays), for example where each array or group is at a different position or depth along the borehole when deployed (e.g. each array of receivers in the multi-level array is located at a different axial position on the tool to which it is attached). For example, a wireline cable may include a set of shuttles, where each shuttle includes a group of sensors (an array) and each shuttle is at a different position along the cable. The set of shuttles then includes a multi-level array of sensors.

“Conventional” sampling theory refers to the theory that a wavefield should be sampled at greater than twice the highest frequency component in the wavefield if there is to be no loss of information.

“Conventional” devices, systems and methods are those devices, systems, and methods wherein sampling requirements are according to conventional theory. This can impose an upper limit on sensor spacing requirements if there is to be no significant loss of spatial wavenumber information.

A “downhole tool” can be any instrumentation used in a borehole such as a bare sensor, or a sensor deployed on a shuttle, or a sensor deployed on a MWD drill string.

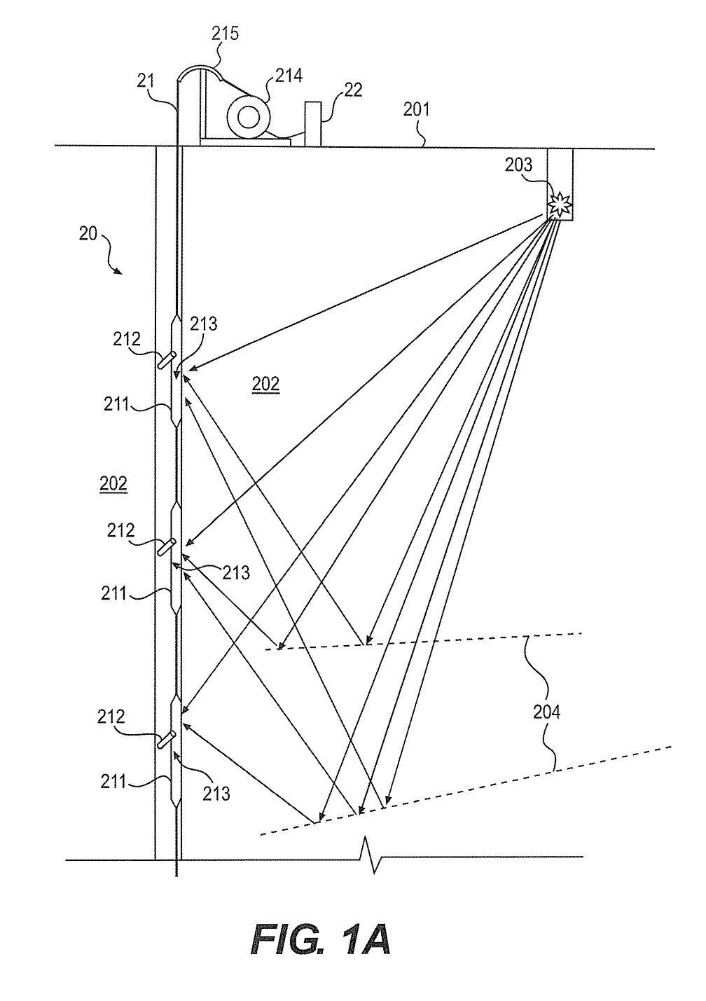

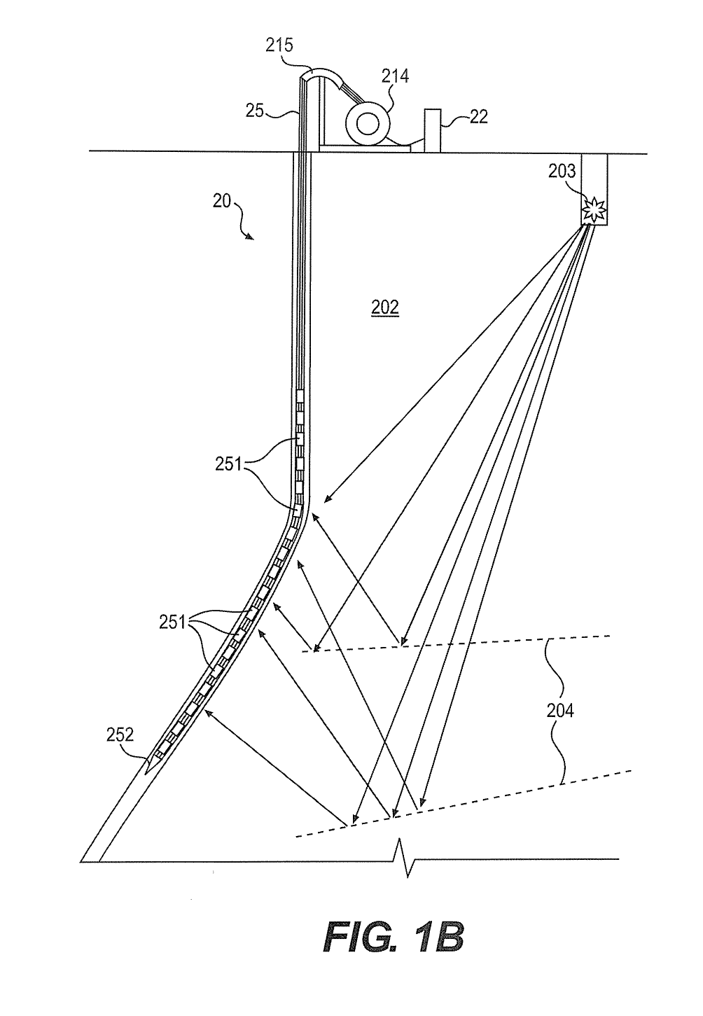

An example of vertical seismic acquisition in a borehole is illustrated in FIG. 1A. A cable 21 carrying a plurality of VSP shuttles 211 is suspended from a surface 201 of a borehole 20 into the borehole 20. System noise is alleviated or avoided by pushing or wedging the shuttles against the formation 202 or any casing surrounding the wellbore 20 using a clamping or locking mechanism 212.

The clamping or locking mechanism 212 can be based on the use of springs, telescopic rams or pivoting arms as shown. The shuttles 211 can carry transducer elements 213 to measure the velocity or acceleration in one or three independent directions. The clamping mechanism 212 ensures that the transducers 213 are coupled to the borehole wall. In a VSP operation, a significant decrease in the signal-to-noise ratio can be observed when the geophone loses contact with the wall of the borehole.

On the surface, a cable reel 214 and feed 215 supports the cable 21. Measurement signals or data are transmitted through the cable 21 to a base station 22 on the surface for further processing. The cable 21 can be an armored cable as used for wireline operations with a plurality of wire strands running through its center.

In operation a source 203 as shown is activated generating seismic waves which travel through the formation 202. Where there are changes in formation impedance (as indicated by dashed lines 204), part of the seismic energy may be reflected and/or refracted. The transducers 213 register movements of the earth and the measurements are transmitted directly or after in-line digitization and/or signal processing to the surface base station for storage, transmission and/or further processing. The subsequent data processing steps are known and well established in the field of hydrocarbon exploration and production.

FIG. 1B illustrates a seismic operation similar to that of FIG. 1A except the shuttle-carrying cable 21 of FIG. 1A is replaced by a cable 25 having a plurality of internal mounts 251 where each mount can accommodate at least two hydrophones. Such an operation is described in U.S. Pat. Pub. No. 2008/0316860 (“the '860 publication”), which is herein incorporated by reference in its entirety. The cable 25 (hereinafter “borehole seismic cable” or “streamer”) has the appearance of a streamer as used in marine seismic acquisitions in that the skin or outer layer of the cable has substantially the same diameter at the locations of the sensors as in between the sensors. The '860 publication describes various configurations of the densely sampled groups of hydrophones to estimate gradients of the wavefield directly from the hydrophone measurements. The distance (depth interval) between these groups of hydrophones is governed by the signal sampling requirements.

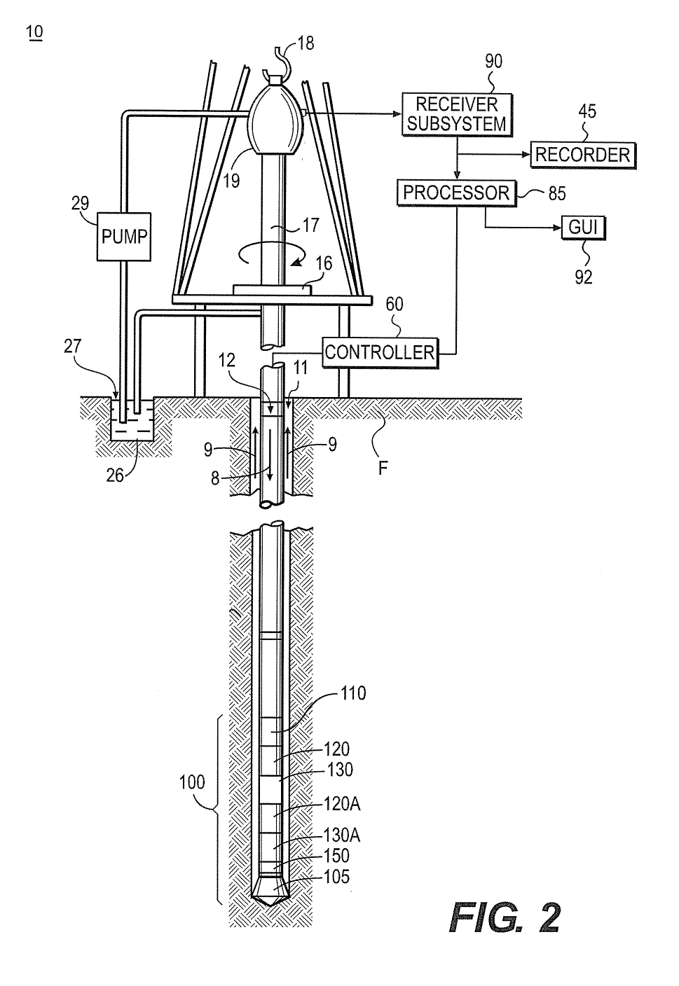

FIG. 2 illustrates a land-based platform and derrick assembly (drilling rig) 10 and drill string 12 with a well data acquisition and logging system, positioned over a wellbore 11 for exploring a formation F. In the illustrated embodiment, the wellbore 11 is formed by rotary drilling in a manner that is known in the art. Those of ordinary skill in the art given the benefit of this disclosure will appreciate, however, that the subject matter of this disclosure also finds application in directional drilling applications as well as rotary drilling, and is not limited to land-based rigs.

The drill string 12 is suspended within the wellbore 11 and includes a drill bit 105 at its lower end. The drill string 12 is rotated by a rotary table 16, energized by means not shown, which engages a kelly 17 at the upper end of the drill string 12. The drill string 12 is suspended from a hook 18, attached to a travelling block (also not shown), through the kelly 17 and a rotary swivel 19 which permits rotation of the drill string 12 relative to the hook 18.

Drilling fluid or mud 26 is stored in a pit 27 formed at the well site. A pump 29 delivers the drilling fluid 26 to the interior of the drill string 12 via a port in the swivel 19, inducing the drilling fluid 26 to flow downwardly through the drill string 12 as indicated by the directional arrow 8. The drilling fluid 26 exits the drill string 12 via ports in the drill bit 105, and then circulates upwardly through the region between the outside of the drill string 12 and the wall of the wellbore 11, called the annulus, as indicated by the direction arrows 9. In this manner, the drilling fluid 26 lubricates the drill bit 105 and carries formation cuttings up to the surface as it is returned to the pit 27 for recirculation.

The drill string 12 further includes a bottomhole assembly (“BHA”), generally referred to as 100, near the drill bit 105 (for example, within several drill collar lengths from the drill bit). The BHA 100 includes capabilities for measuring, processing, and storing information, as well as communicating with the surface. The BHA 100 thus may include, among other things, at least one logging-while-drilling (“LWD”) module 120, 120A and/or at least one measuring-while-drilling (“MWD”) module 130, 130A. The BHA 100 may also include a roto-steerable system and motor 150.

The LWD and/or MWD modules 120, 120A, 130, 130A can be housed in a special type of drill collar, as is known in the art, and can contain at least one type of logging tools for investigating well drilling conditions or formation properties. The logging tools may provide capabilities for measuring, processing, and storing information, as well as for communication with surface equipment.

The BHA 100 may also include a surface/local communications subassembly 110, which enables communication between the tools in the LWD and/or MWD modules 120, 120A, 130, 130A and processors at the earth's surface. For example, the subassembly 110 may include a telemetry system that includes an acoustic transmitter that generates an acoustic signal in the drilling fluid (a.k.a. “mud pulse”) that is representative of measured downhole parameters. The acoustic signal is received at the surface by instrumentation that can convert the acoustic signals into electronic signals. For example, the generated acoustic signal may be received at the surface by transducers. The output of the transducers may be coupled to an uphole receiving system 90, which demodulates the transmitted signals. The output of the receiving system 90 may be coupled to a computer processor 85 and a recorder 45. The computer processor 85 may be coupled to a monitor, which employs graphical user interface (“GUI”) 92 through which the measured downhole parameters and particular results derived therefrom are graphically or otherwise presented to the user. In some embodiments, the data is acquired real-time and communicated to the back-end portion of the data acquisition and logging system. In some embodiments, the well logging data may be acquired and recorded in the memory in downhole tools for later retrieval.

The LWD and MWD modules 120, 120A, 130, 130A may also include an apparatus for generating electrical power to the downhole system. Such an electrical generator may include, for example, a mud turbine generator powered by the flow of the drilling fluid, but other power and/or battery systems may be employed additionally or alternatively.

The well-site system is also shown to include an electronics subsystem having a controller 60 and a processor 85, which may optionally be the same processor used for analyzing logging tool data and which together with the controller 60 can serve multiple functions. The controller and processor need not be on the surface as shown but may be configured in any way known in the art. For example, alternatively, or in addition, as is known in the art, the controller and/or processor may be part of the MWD (or LWD) modules on which the sensor array according to this disclosure may be positioned.

In the methods, systems and devices according to this disclosure, the electronics subsystem (whether located on the surface or sub-surface on or within the tool or some combination thereof) may include machine-readable instructions for computing at least one wavefield derivative, and/or reconstructing an unaliased wavefield (i.e. reconstructing data at virtual or interpolated receivers).

The devices, systems and methods according to this disclosure are applicable to both wireline and MWD operations, and any other method of borehole investigation for example methods involving lowering streamers including borehole seismic sensors into the wellbore. The devices, systems and methods according to this disclosure may be adapted for use in vertical, deviated and horizontal wellbores. Thus, the devices, systems and methods according to this disclosure may also be adapted for use in nearly any downhole seismic acquisition system, for example, wireline Vertical Seismic Profiles (“VSP”), cross-well seismic, “seismic-while-drilling” and “passive seismic” (in either case where receivers may be deployed along the drill string), among other borehole seismic techniques. As a person of skill should appreciate from reading this disclosure, the devices, systems and methods according to this disclosure may also have application in hydraulic fracture monitoring or any other downhole procedure in which spatial aperture may be restricted, for example by the number of shuttles deployed.

In general, the present disclosure provides devices, systems and methods which reduce the sampling requirement for seismic operations. Conventional sampling theory suggests that any wavefield should be sampled at greater than twice the highest frequency component in the wavefield if there is to be no loss of information. This can impose an upper limit on sensor spacing requirements if there is to be no significant loss of spatial wavenumber information. In terms of borehole seismic, this implies that there is a maximum intra-sensor spacing that cannot be exceeded if spatial aliasing is to be avoided. In other words, the sensor spacing is chosen to have at least two samples per maximum frequency in the wavefield of interest (alternatively at least two samples per shortest wavelength in the wavefield of interest.) For conventional borehole seismic surveys, such as VSP, this spacing is about 50 ft (15 m).

However, as shown in this disclosure, if the wavefield and its derivative(s) can be coincidentally measured then the sampling requirement is reduced to sampling at discrete intervals at or above the highest spatial frequency in the data. In plain terms, by adding wavefield derivative measurements, the sampling requirement can be reduced by half (e.g. the distance between receivers—or in the present case, the distance between receiver groups—is doubled). Returning to conventional borehole seismic surveys, such as VSP, this implies that the sensor spacing can be increased to about 100 ft (30 m) without loss or substantial loss of information. This arrangement may be, for example, advantageous in MWD services or Wired Drilled pipe applications or other services where sensor spacing is primarily driven by drilling logistics and physical restrictions. This disclosure provides devices and systems, for example including configurations of receivers and multi-level receiver arrays for sampling data corresponding to a desired wavefield and at least one of its derivatives, and methods for computing wavefield derivatives and reconstructing from the wavefield and wavefield derivative data the unaliased wavefield.

As previously discussed, conventional sampling theory, as originally described by Shannon-Nyquist, suggests that data be sampled at a frequency greater than twice the highest frequency contained in the signal. However, in the case that not only the signal is recorded but also the derivative of the signal, then the sampling frequency need only be greater than the highest frequency contained in the signal. This extension to the Shannon-Nyquist sampling theory to include derivatives is known as the multi-channel sampling theory (Linden 1995).

Mathematically, the Shannon-Nyquist theorey can be written as

$$[ u ( {x}_{0} ) = {\sum }_{k = - ∞}^{∞} u ( \frac{k}{Δ} ) [ sin c ( Δ {x}_{0} - k ) ] \qquad [ 1 ]$$

which describes how a signal u(x) regularly sampled at intervals of Δ can be reconstructed at any intermediate point x₀. Such a reconstruction process is often referred to as sinc interpolation.

The multi-channel sampling theory extends the Shannon-Nyquist theory to situations where measurements are available of both the signal and also the signal's derivative(s):

$$u ( {x}_{0} ) = {\sum }_{k = - ∞}^{∞} u ( \frac{2 k}{Δ} ) + ( {x}_{0} - \frac{2 k}{Δ} ) \frac{\partial u}{\partial t} {( \frac{2 k}{Δ} ) [ sin c ( \frac{Δ {x}_{0}}{2 } - k ) ]}^{2} \qquad [ 2 ]$$

Thus, it can be seen that when both a signal and its derivative(s) are available, the sampling requirement is half of that compared to the case when only the signal is measured. Furthermore, in the case that higher order derivatives are available, the sampling requirement becomes even sparser. For example, in the case that a signal and its first and second order derivatives are available, the signal need be sampled at a third of the rate compared to the case that only the signal itself is available. While equations 1 and 2 above are written in terms of spatial sampling, the same equations also apply to temporal sampling.

The present disclosure provides devices, systems and methods for measuring wavefield derivatives. The devices and systems include sensor groups configured according to spatial sampling requirements for measuring wavefield derivatives, and sensor groups configured according to temporal sampling requirements for measuring wavefield derivatives. The methods include methods of using such devices and systems, including to generate data that is substantially free from aliasing.

Devices. In some embodiments, the device includes an array of sensors for acquiring data corresponding to a wavefield and at least one of the wavefield's derivatives. In some embodiments, the device includes an array of sensors for acquiring data corresponding to a wavefield and its first derivative. In some embodiments, the device includes an array of sensors for acquiring data corresponding to a wavefield and its first and higher order derivatives. In some embodiments, the device includes an array of sensors for acquiring data corresponding to a wavefield and its first and second derivatives.

As described in more detail below, devices which acquire such data according to temporal sampling requirements generally include an array of at least two different, co-located sensors. “Different” means that one sensor measures the wavefield signal and the other sensor or sensors measure wavefield derivatives. “Co-located” means that the sensors are located at the same depth level (e.g. axial position along the shuttle to which they are attached). Systems which acquire such data according to temporal sampling requirements generally include two arrays of at least two different, co-located sensors, where the inter-array distance is according to conventional theory (i.e. the inter-array spacing is chosen to have at least two samples per maximum frequency in the wavefield of interest or at least two samples per shortest wavelength in the wavefield of interest). It is understood that the “inter-array distance” is measured from the central point in one group of receivers to the central point in another group of receivers. Although the inter-array spacing matches that of conventional devices, the temporal sampling requirement is cut in half for each individual sensor in an array having displacement and velocity sensors (i.e. half the data need be collected in a given time frame for each sensor versus conventional devices), and is cut in a third for each individual sensor in arrays further having acceleration sensors (i.e. a third of the data need be collected in a given time frame for each individual sensor versus conventional devices).

As also further described below, devices which acquire such data according to spatial sampling requirements generally include an array of at least two same-type, closely-spaced sensors. “Same-type” means that the sensors measure one of displacement, velocity, or acceleration or otherwise make the same measurement. “Closely-spaced” means that the sensors are effectively at the same depth level, however they are axially staggered one from the other such that at least one wavefield derivative may be computed from the data collected by the array. Generally speaking, this means the sensors should be staggered by at least a minimum distance but not more than a maximum distance. The minimum and maximum distance can be determined by a person of skill based upon reading this disclosure. Also, generally speaking, the number of sensors in an array is one more than the highest order derivative desired. For example, two sensors are used to sample data corresponding to the wavefield and the first wavefield derivative, and three sensors are used to further sample data corresponding to the second wavefield derivative.

Temporal Sampling Devices. In some embodiments according to the present disclosure, the device includes an array of at least two substantially (effectively) co-located sensors, where at least one sensor measures a wavefield and at least one sensor measures a derivative of the wavefield. In the seismic field the wavefield can be measured using a geophone which measures the particle velocity, denoted v(t). However, the seismic signal may also be recorded using accelerometers which measure the wavefield's particle acceleration, a(t) which is the second derivative of the displacement and the first derivative of the particle velocity. Finally, the displacement associated with a seismic wavefield can also be measured. Thus, for example, the array may include: a sensor that measures displacement; and, a sensor that measures velocity; and, optionally the device may further include a sensor that measures acceleration. When the array includes a displacement sensor and a velocity sensor, the signal need only be recorded at half the sampling frequency compared to the case that the signal is recorded with either sensor alone. Where the array further includes an acceleration sensor, the sampling rate can be further reduced to a third of the original sampling rate. The displacement sensors, velocity sensors, and acceleration sensors can be any sensors suitable for use in acquiring borehole seismic information. For example, the velocity sensors may be geophones and the acceleration sensors may be accelerometers.

Spatial Sampling Devices. In some embodiments, the device includes an array of closely-spaced, same-type sensors. For example, in some embodiments, the array includes at least two closely-spaced geophones, or at least two closely-spaced hydrophones, or at least two closely-spaced accelerometers. In some embodiments, the array includes at least three closely-spaced, same-type seismic sensors.

In some embodiments, “closely-spaced” is the distance (range of acceptable distances) between sensors in an array that permits a first wavefield derivative to be computed from the acquired data. In some embodiments, “closely-spaced” is the distance (range of acceptable distances) between sensor arrays that permits at least a first and a second wavefield derivative to be computed from the acquired data. In some embodiments, “closely-spaced” is the distance (range of acceptable distances) that permits at least a first derivative (i.e. permits a first derivative and possibly at least one higher order derivative) to be computed from the acquired data.

In some embodiments, the intra-array spacing (the distance between sensors in a given array) is about ¼ the wavelength of the shortest wavelength of interest. In some embodiments, the intra-array spacing is no more than about 0.5 m. A person of skill, after reading this disclosure, should be able to determine appropriate intra-array spacings taking into account the goal of computing wavefield derivatives and transformed wavefield data that is substantially unaliased from the wavefield and derivative data, and taking into account, for example, tool restrictions, formation velocity, and other appropriate/relevant parameters.

Devices including sensor arrays for sampling data corresponding to a desired wavefield and at least one of its derivatives, may further include an electronics subsystem for computing wavefield derivatives from the sampled data and/or for reconstructing data at a virtual receiver from the wavefield and derivative data. One way of measuring the derivative of the wavefield is to use an array of closely-spaced sensors and compute the wavefield derivatives using finite difference approximations. In the case that two closely-spaced geophones are available, for example, then the second order accurate centered finite difference approximation of the wavefield's spatial derivative is:

$$\frac{\partial v ( t , {l}_{0} )}{\partial l} = \frac{v ( t , {l}_{0} - Δ ) - v ( t , {l}_{0} + Δ )}{2 Δ} \qquad [ 3 ]$$

More accurate spatial derivatives and higher order derivatives can also be derived in the case that more geophones are available in the closely-spaced array. For example, in the case that five receivers are available then the centered finite difference approximation of the wavefield's derivative is:

$$\frac{\partial v ( t , {l}_{0} )}{\partial l} = \frac{- v ( t , {l}_{0} + 2 Δ ) + 8 b ( {l}_{0} + Δ ) - 8 v ( t , {l}_{0} - Δ ) + v ( {l}_{0} - 2 Δ )}{12 Δ} \qquad [ 4 ]$$

(also known as the five point finite difference stencil).

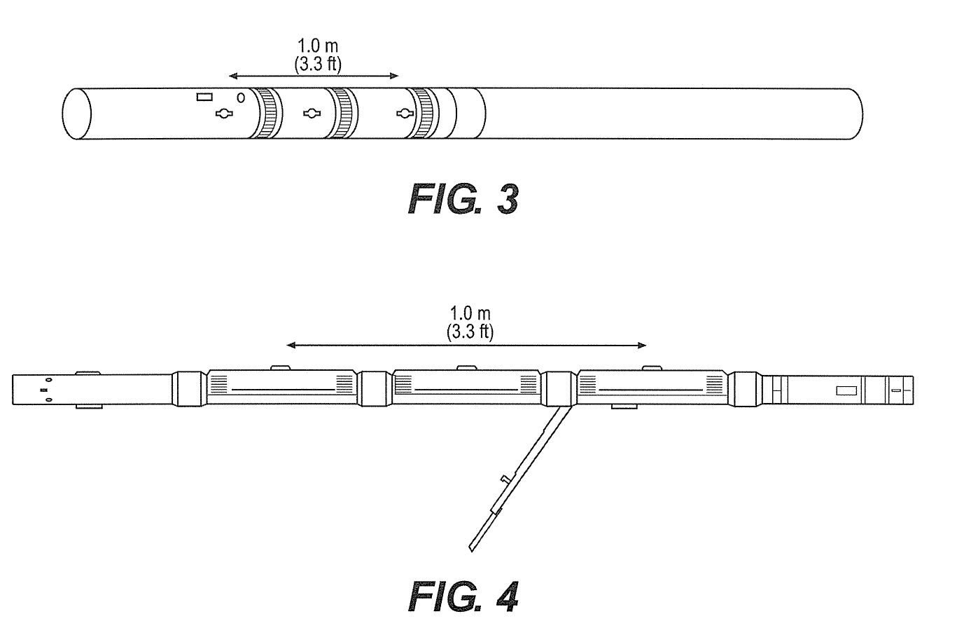

FIGS. 3 and 4 are schematic illustrations of non-limiting exemplary tools useful for borehole seismic surveying according to this disclosure. FIG. 3 is a conceptual tool sized to fit in a borehole and including two sets of three receivers, where the intra-receiver spacing in each set is about 0.5 m. In the specifically illustrated embodiment, the tool includes three accelerometers where adjacent accelerometers are axially-spaced about 0.5 m from each other, and three hydrophones, where adjacent hydrophones are axially-spaced about 0.5 m from each other. Such a configuration may provide redundancy in data and may improve accuracy.

FIG. 4 provides a conceptual seismic shuttle including three sets of 3C receivers spaced approximately 0.5 m apart. In some embodiments an additional multi-level array of receivers, for example a multi-level array of hydrophones, may be interspersed with the first multi-level array to provide redundancy.

Systems/Methods. Devices, or groups of sensors described according to this disclosure, which permit measuring data corresponding to a wavefield and its derivative(s), enable systems and methods for sampling seismic data at greater than conventional spatial separation (increased inter-array spacing) or greater than conventional temporal separation (increased time between data sampling), but nevertheless permit reconstruction of an unaliased (substantially unaliased) wavefield comparable to conventional results. In other words, by adding wavefield derivative measurements, systems and methods can be developed where sampling requirements are reduced by at least half that of conventional systems and methods, for example systems can be designed with sensor spacing in borehole seismic applications of about 100 ft (30 m) versus about 50 ft (15 m), or measurements can be taken every about 100 ft (30 m) versus every about 50 ft (15 m), without resulting in any loss or substantial loss of information.

Systems which acquire such data according to spatial sampling requirements can include two arrays of at least two same-type, closely-spaced sensors, where the inter-array distance is increased relative to conventional theory. Specifically, where conventional theory suggests that the inter-array spacing is chosen to have at least two samples per maximum frequency in the wavefield of interest or at least two samples per shortest wavelength in the wavefield of interest, according to the present disclosure, the inter-array spacing for spatially-configured devices may be twice that of conventional devices for arrays having two same-type, closely-spaced sensors, and may be three times that of conventional devices for arrays having three same-type, closely spaced arrays.

The systems may further include an electronics subsystem having machine-readable instructions for computing wavefield derivatives and/or for reconstructing data that is substantially free of aliasing, for example comparable to systems acquiring data according to conventional sampling requirements (e.g. according to the Shannon-Nyquist theory).

For example, a further application of the multi-channel sampling theory discussed above can be considered for downhole seismic recordings sometimes referred to as VSP. Such surveys are typically obtained using a seismic source deployed on the surface and deploying a multi-level array of geophones (or accelerometers) in a borehole where the spacing between the receivers is selected to avoid spatial aliasing. This spacing can range from about 10 m to about 15 m (30 ft to 50 ft). A finer sampling can be achieved by acquiring two sequential surveys with the downhole seismic array shifted in depth. The resulting merged dataset created from the interleaving of the two datasets has an effective finer sampling. Unfortunately, such datasets are subject to changes during the two acquisitions, for example, due to sea swell in marine acquisitions. However, in the case that measurements of the wavefield and the wavefield's spatial derivative are available, it is possible to double the receiver spacing (e.g. ranging from about 20 m to about 30 m (60 to 90 ft)) without introducing spatial aliasing. Another way of saying this is that data at a “virtual” receiver position can be constructed between coarsely spaced receivers without loss of information.

For Walkaway and 3D VSPs an array of borehole seismic sensors can be deployed downhole, including from about 40 to about 100 shuttles with each shuttle containing one set (group) of sensors. Simply put, the disclosure provides systems of downhole arrays with increased sensor spacing as compared to what is suggested by conventional theory. This disclosure also provides methods of obtaining unaliased (substantially unaliased) wavefield data despite sampling data using greater spatial or temporal separation as compared to what is suggested by conventional theory. The systems/methods are not limited to implementation in shuttles or MWD, but can apply to any arrangement where wavefield derivatives can be measured/computed and those derivatives can be used to interpolate data at “virtual” positions.

In addition, the present disclosure may allow increasing, for example doubling or tripling, the effective depth span covered by an array of sensors (e.g. an array of shuttles or an array of sensors along a drill string). The “missing” depth levels can be recovered using interpolation from the sensor groups (e.g. from the shuttles) where wavefield and its derivative(s) are measured. Thus, for example, a conventional arrangement may include 8 shuttles, each about 15 m apart. The resulting aperture (depth span) is about 105 m. According to the present disclosure, the aperture could be, for example, doubled to about 210 m without loss or substantial loss of information (for example because the sampled data may be used to reconstruct the data at “virtual” shuttles—as if 16 shuttles were used although only 8 shuttles are deployed), resulting in sampling a greater length of the borehole in one experiment.

To demonstrate the principles of this disclosure, a synthetic VSP dataset using finite difference modeling is created. The model is an isotropic elastic homogenous half space with Vp=2.5 km/s and Vs=1.25 km/s. The source is located just below the surface and receivers are located directly below the source at a depth of 1005 m.

In the first modeling scenario (according to conventional theory), 34 receivers are spaced every 15 m (50 ft). In the second modeling scenario, 16 receivers are vertically spaced at 30 m (100 ft). The first modeling scenario corresponds to a wireline VSP acquisition, while the second scenario corresponds to an MWD acquisition where the receiver interval is determined by the stand length of the drill pipe (typically 90 ft). The source wavelet used is a Ricker wavelet with a peak frequency of 15 Hz.

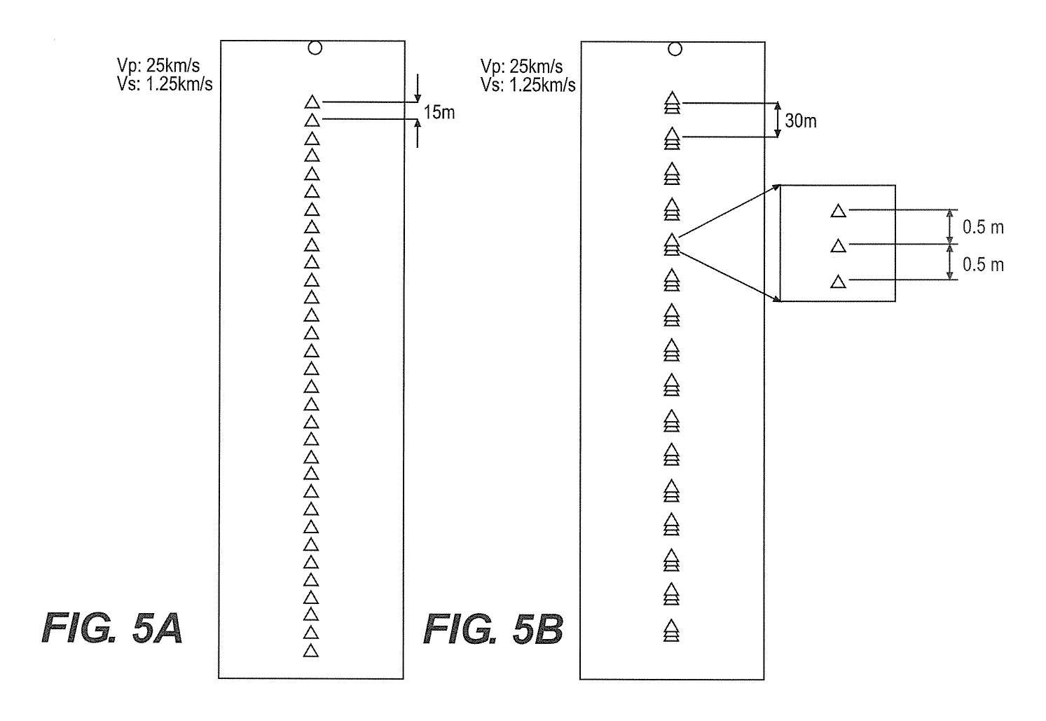

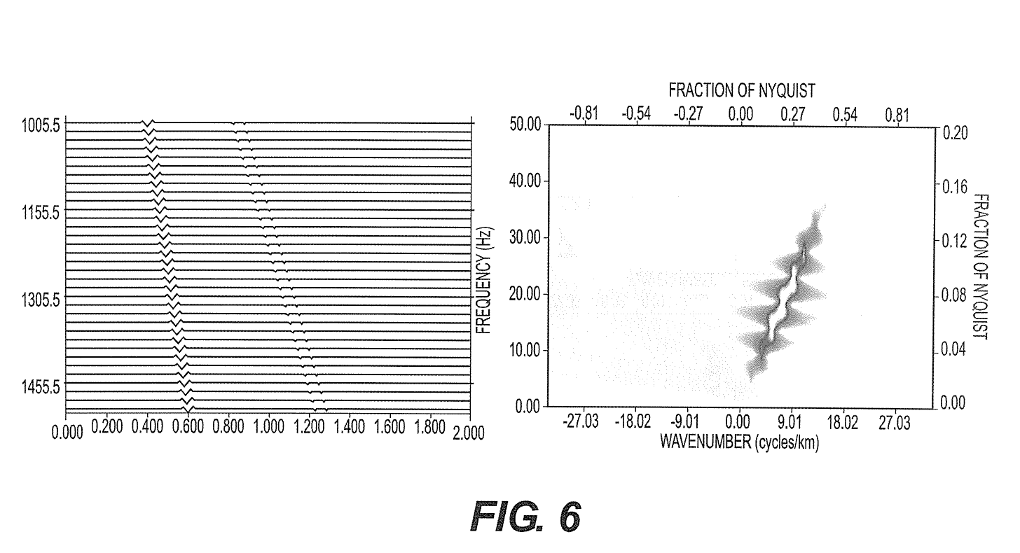

In the first scenario, corresponding to a wireline VSP acquisition, the direct P-wave arrives at the shallowest receiver at about 0.4 seconds and the moveout over the multi-level array is linear as the multi-level array is vertical, the model is 1D and the source lies directly above the receiver (see FIG. 5A). A secondary SV-wave arrives at the shallowest receiver around 0.85 seconds. This data is transformed into the f-k domain (frequency-number) as shown in FIG. 6. The P-wave arrivals transform into the linear feature lying along the line annotated at 2.5 km/s. The SV-wave arrivals transform into the subtle linear feature aligned along the line annotated at 1.25 km/s. Thus it can be seen that data recorded with 15 m sampling (VSP wireline scenario) may be free from spatial aliasing effects.

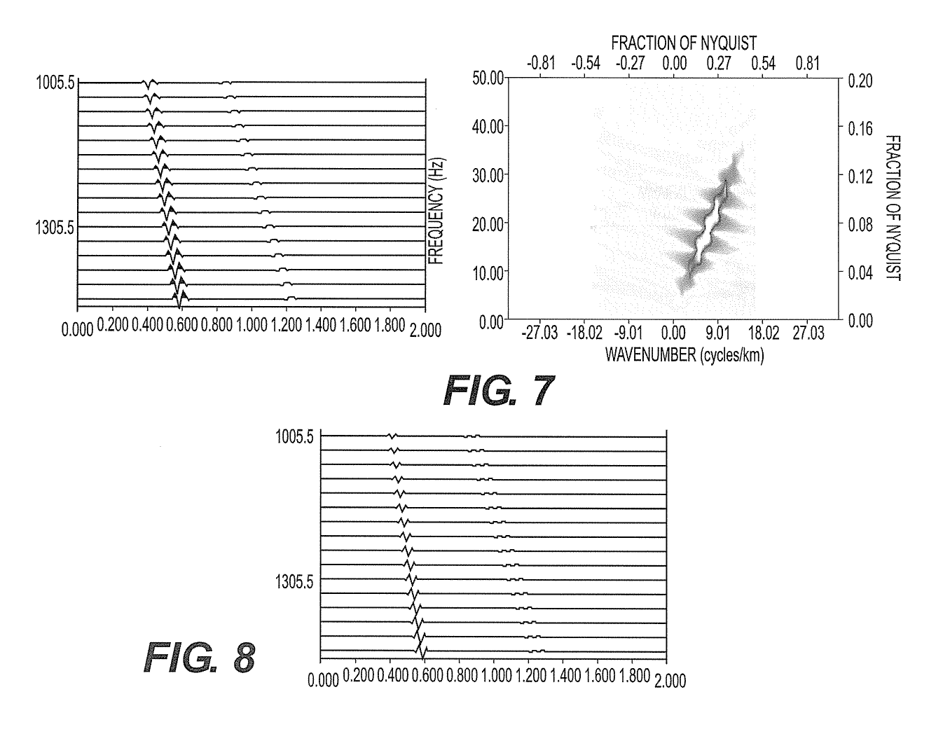

In the second scenario, corresponding to an MWD acquisition, the data from the first scenario can be decimated by two, i.e. every other receiver level is removed (see FIG. 5B). In this case, the f-k transformed data shows aliasing effects (see FIG. 7) for both the P and SV data. In the case of the P-wave arrivals the data are aliased at frequencies above 40 Hz while the slower SV arrivals are aliased above frequencies of 20 Hz.

However, if the multi-level array is modified to include a multi-level array of sensor groups, i.e. if additional sensors are deployed 0.5 m above and below each original receiver (forming sensor groups with a central receiver and a receiver 0.5 m above the central receiver and a receiver 0.5 m below the central receiver) (FIG. 5B, inset), the wavefield derivative can be computed using finite differences (or other suitable signal processing algorithms), see FIG. 8. Using the wavefield derivative and the wavefield from the central receiver, the unaliased wavefield at intermediate spatial locations can then be reconstructed thereby overcoming the limitations that may be imposed by the MWD environment.

A number of embodiments have been described. Nevertheless it will be understood that various modifications may be made without departing from the spirit and scope of the invention. Accordingly, other embodiments are included as part of the invention and may be encompassed by the attached claims. Furthermore, the foregoing description of various embodiments does not necessarily imply exclusion. For example “some” embodiments or “other” embodiments may include all or part of “some,” “other” and “further” embodiments within the scope of this invention.

What is claimed is:

1. A device for borehole seismic surveying, comprising: a downhole tool comprising a group of at least two seismic sensors configured to sample data corresponding to a wavefield and at least one derivative of the wavefield.

2. A device according to claim 1, wherein the data corresponding to the at least one derivative of the wavefield is sampled directly by at least one sensor in the group.

3. A device according to claim 2, wherein the group of at least two seismic sensors comprises a sensor that measures displacement and a sensor that measures velocity and the sensors are co-located at substantially the same depth level along the tool.

4. A device according to claim 2, wherein the at least two seismic sensors comprise at least three seismic sensors configured to sample data corresponding to a wavefield, a first derivative of the wavefield, and a second derivative of the wavefield, and further wherein the at least three seismic sensors comprise a sensor that measures displacement, a sensor that measures velocity, and a sensor that measures acceleration and the at least three seismic sensors are co-located at substantially the same depth level along the tool.

5. A device according to claim 1, wherein the device further comprises an electronics subsystem for computing the at least one derivative of the wavefield from the sampled data.

6. A device according to claim 5, wherein the at least two seismic sensors comprise same type of sensors, and each one of the same type of sensors is axially spaced apart from another one of the same type of sensors a distance appropriate to acquire data from which the at least one derivative of the wavefield can be computed.

7. A device according to claim 6, wherein the at least two seismic sensors comprise at least two sensors that measure displacement, or at least two sensors that measure velocity, or at least two sensors that measure acceleration.

8. A device according to claim 6, wherein the at least two seismic sensors comprise at least two geophones, or at least two hydrophones, or at least two accelerometers, or at least two geophone-accelerometers.

9. A system for borehole seismic surveying, comprising: an array of seismic sensor groups, wherein each group in the array comprises at least two seismic sensors configured to sample data corresponding to a wavefield and at least one derivative of the wavefield, and the inter-group spacing corresponds to a spatial sampling rate that is at least half of a conventional spatial sampling rate.

10. A system according to claim 9, wherein the inter-group spacing is chosen to result in a sampling rate of about one sample per shortest wavelength in a target wavefield.

11. A system according to claim 9, wherein the inter-group spacing is at least twice or three times the spacing suggested by conventional theory.

12. A system according to claim 9, further comprising an electronics subsystem for computing a substantially unaliased wavefield from the sampled data.

13. A system according to claim 12, wherein each group comprises at least two closely-spaced, same-type seismic sensors that are at least two displacement sensors, or at least two velocity sensors, or at least two acceleration sensors.

14. A method for borehole seismic surveying, comprising:
a. deploying a group of at least two same-type seismic sensors downhole, wherein the sensors are configured to sample data corresponding to a wavefield and at least one derivative of the wavefield;
b. firing a seismic source;
c. computing the at least one derivative of the wavefield.

15. A method according to claim 14, wherein the at least one derivative of the wavefield is computed using finite difference approximations.

16. A method according to claim 14, further comprising deploying more than one group of sensors downhole, wherein the inter-group spacing corresponds to a spatial sampling rate that is at least half of a conventional spatial sampling rate.

17. A method according to claim 16, wherein deploying comprises lowering a set of shuttles into a borehole, wherein a group of sensors is located on each shuttle, and the shuttles are disposed along a wireline cable at a distance resulting in said inter-group spacing.

18. A method according to claim 17, further comprising using a measurement of the wavefield along with its derivative to reconstruct data at an interpolated virtual receiver.

19. A method according to claim 16, wherein deploying comprises lowering a wireline cable into a borehole, the wireline cable comprising at least two shuttles, wherein each shuttle includes a group of at least two closely-spaced, same-type sensors, and the shuttles are separated by a distance resulting in a spacing between the groups of sensors corresponding to a spatial sampling rate that is at least half of a conventional spatial sampling rate.

20. A method according to claim 16, wherein deploying comprises lowering a drill string including at least one MWD tools into a borehole, wherein each MWD tool includes at least one group of at least two closely-spaced, same-type sensors.
